(19) United States
(12) Patent Application Publication
(10) Pub. No.: US 2016/0290554 A1
(43) Pub. Date: Oct. 6, 2016

(54) MODULE MOUNTING SYSTEM

(71) Applicant: Solar Turbines Incorporated, San Diego, CA (US)

(72) Inventors: Nicholas O. Saintarbor, San Diego, CA (US); David C. Taylor, San Diego, CA (US); Christopher M Moffatt, San Diego, CA (US); Darren M. Stratton, San Diego, CA (US)

(73) Assignee: Solar Turbines Incorporated, San Diego, CA (US)

(21) Appl. No.: 15/181,958

(22) Filed: Jun. 14, 2016

(51) Int. Cl. F16M 13/02

(52) U.S. Cl. CPC F16M 13/02

(57) ABSTRACT

A module mounting system for a structure is provided. The module mounting system includes a supporting member having at least one slot. The module mounting system also includes at least one mounting assembly coupled to the at least one slot. The at least one mounting assembly is adapted to couple the supporting member with the structure. The at least one mounting assembly is movable within the at least one slot. The at least one mounting assembly includes a first mounting member. The at least one mounting assembly also includes a second mounting member having a first portion and a second portion. The first portion is received within the at least one slot. The first mounting member is coupled with the second mounting member through a first fastening member. The first mounting member and the second mounting member are coupled with the structure through a second fastening member.

### TECHNICAL FIELD

The present disclosure relates to a module mounting system, and more particularly to a mounting system for a module.

### BACKGROUND

Module mounting systems for mounting modules, such as fuel modules, vary with a type of structure on which the modules are mounted. Generally, the module mounting systems include adapter plates for mounting the modules on various different structures. The design of an adapter plate changes with the type of module and/or structure it is being mounted to. Thus, specific adapter plates are required to be developed for mounting the module on a particular structure. Design and development of the adapter plates involve a significant amount of time and cost investment. Additionally, skilled personnel are required for performing hot working process, such as welding, cutting, and grinding, for developing the adapter plates. Further, iterative mounting of the modules may be inefficient and cumbersome.

U.S. Pat. No. 6,488,256, hereinafter referred to as '256 patent, describes an adjustable mounting bracket. The adjustable mounting bracket includes two frames juxtaposed to slide on each other and attached by nuts and bolts. Each of the two frames is U-shaped with an internal T-shaped opening. The T-shaped opening is formed by a shoe plate formed between the end plate and two side plates. Slots and holes in the shoe plate are used to connect the two frames together and adjust a central working space for use with either a circular saw or a router. Slots in the shoe plate in conjunction with locking pieces are used to attach the power hand tool to the mounting bracket. The length of the mounting bracket is adjustable to be suitable for power hand tools such as a circular saw or a router that have different sizes. However, the adjustable mounting bracket described in the '256 patent includes multiple components which may increase a cost and design complexity of the mounting bracket.

### SUMMARY OF THE DISCLOSURE

In one aspect of the present disclosure, a module mounting system for a structure is provided. The module mounting system includes a supporting member adapted to couple to the structure. The supporting member includes a top surface, a bottom surface disposed opposite to the top surface, and at least one slot extending between the top surface and the bottom surface. The module mounting system also includes at least one mounting assembly coupled to the at least one slot. The at least one mounting assembly is adapted to couple the supporting member with the structure. The at least one mounting assembly is movable within the at least one slot along a first axis and a second axis. The at least one mounting assembly includes a first mounting member having a first surface, a first aperture, and a second aperture. A portion of the first surface is adapted to abut with the top surface of the supporting member. The at least one mounting assembly also includes a second mounting member having a first portion, a second portion, a third aperture, and a fourth aperture. The first portion is received within the at least one slot. Further, an upper surface of the second portion is adapted to abut with the bottom surface of the supporting member. The at least one mounting assembly includes a first fastening member adapted to couple the first mounting member with the second mounting member. The first aperture is aligned with the third aperture to receive the first fastening member there through. Further, the at least one mounting assembly includes a second fastening member adapted to couple the first mounting member and the second mounting member with the structure. The second aperture, the fourth aperture, and an aperture in the structure are aligned to receive the second fastening member there through.

Other features and aspects of this disclosure will be apparent from the following description and the accompanying drawings.

### BRIEF DESCRIPTION OF THE DRAWINGS

FIG. 1 is a perspective view of a module mounting system for a structure, according to one embodiment of the present disclosure;

FIG. 2 is an exploded side view of a mounting assembly associated with the module mounting system of FIG. 1;

FIG. 3 is a side cross-sectional view of an encircled portion “A” of FIG. 1, illustrating the module mounting system having the mounting assembly; and

FIG. 4 is a top view of the module mounting system of FIG. 1.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

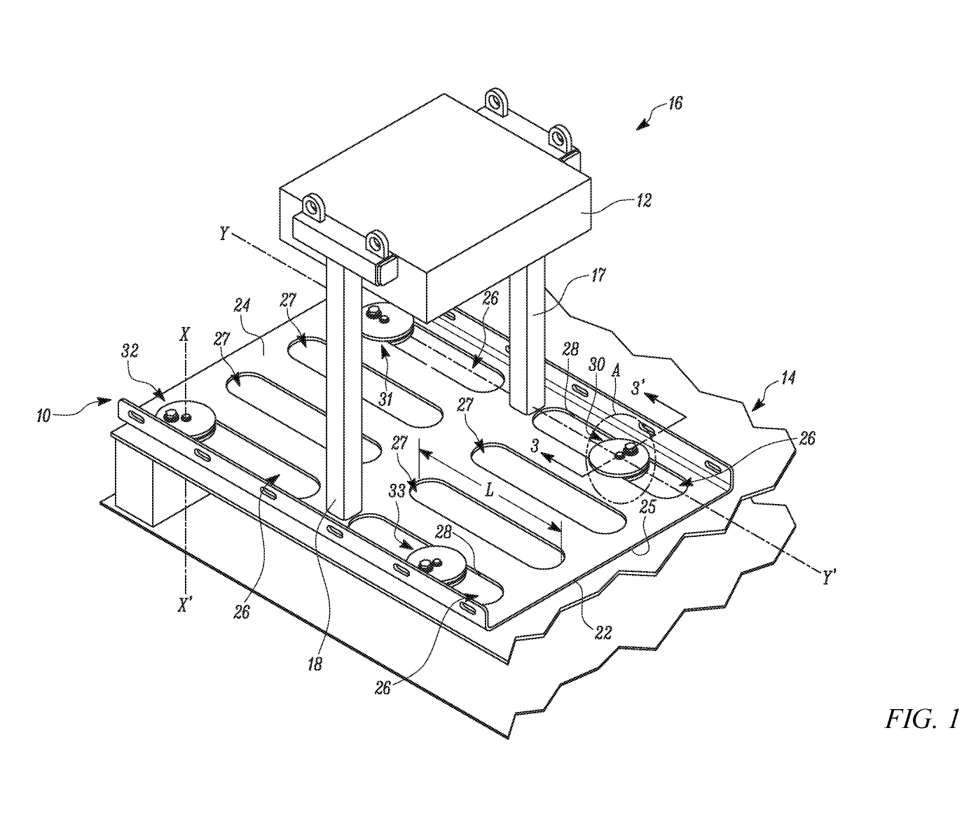

FIG. 1 is a perspective view of a module mounting system 10 for a structure 14, according to one embodiment of the present disclosure. The structure 14 may be embodied as a frame of a packaging unit (not shown) for supporting a process system (not shown). The process system may include, but is not limited to, a batch processing system, a bio-waste deactivation system, a centrifuge system, a chemical processing system, a petroleum processing system, a lubrication system, a seal system, an air conditioning system, a gas fuel system, and a fuel delivery system.

The process system may include a number of modules 12 for performing various operations, based on a type of the process system. The module mounting system 10 disclosed herein receives at least one such module 12. In one example, the process system may be embodied as a fuel delivery system (not shown). Further, the module 12 is a part of a fuel module of the process system. It should be noted that the type of process system and the module 12 disclosed herein are purely exemplary, and do not limit the scope of the present disclosure. Accordingly, the module mounting system 10 can hold and support any module 12 associated with a known process system, without departing from the scope of the present disclosure.

In one example, the module mounting system 10 includes a platform 16 that allows coupling of the module 12 with a supporting member 22. The platform 16 includes a pair of vertical members 17, 18. The platform 16 also includes a horizontal member (not shown) extending between the vertical members 17, 18.

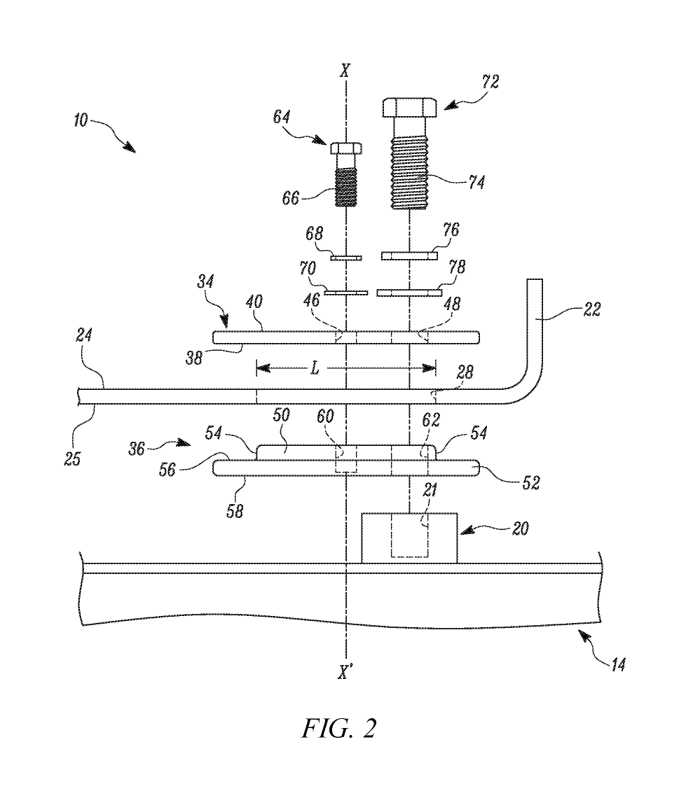

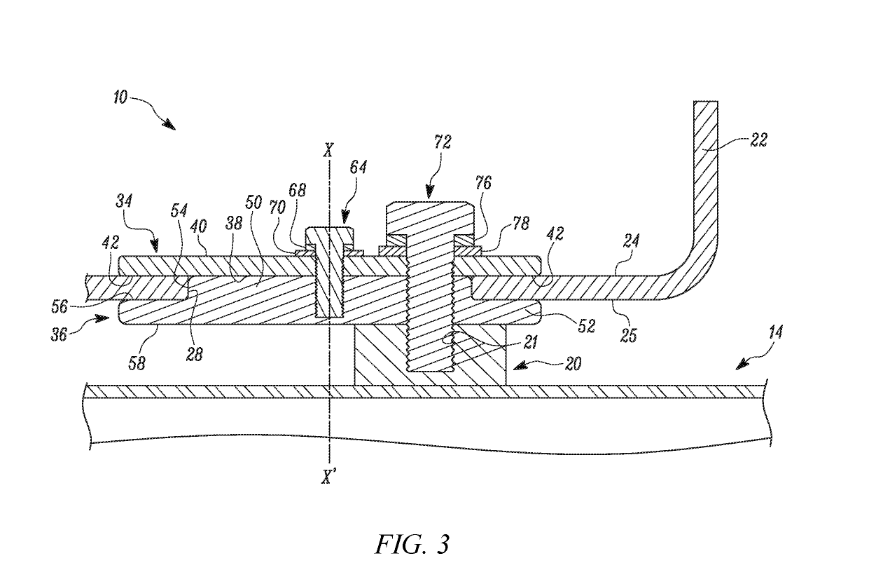

As illustrated, the module mounting system 10 is coupled to the structure 14 of the packaging unit. More specifically, the module mounting system 10 is removably coupled to a number of mounting bosses 20 (one of which is shown in FIG. 2 and FIG. 3) disposed on the structure 14. The mounting bosses 20 allow coupling of the module mounting system 10 to the structure 14. For exemplary purposes, the present disclosure describes four such mounting bosses 20 being associated with the structure 14. However, it should be noted that a number of the mounting bosses 20 may vary based on a size of the structure 14 and a size of the module 12 to be mounted on the structure 14. Each of the mounting bosses 20 include an aperture 21 (shown in FIGS. 2 and 3) having internal threads. In an alternate example, the structure 14 may include a number of through holes for coupling the module mounting system 10 to the structure 14.

The module mounting system 10 includes the supporting member 22. The supporting member 22 includes atop surface 24 and a bottom surface 25 (shown in FIG. 2). The bottom surface 25 is disposed opposite to the top surface 24. The supporting member 22 also includes a number of slots 26 and a number of slots 27. The slots 26, 27 extend between the top surface 24 and the bottom surface 25. Specifically, each of the slots 26, 27 extends along a first axis X-X′ between the top surface 24 and the bottom surface 25. Each of the slots 26, 27 has a length “L” extending along a second axis Y-Y′. The slots 26, 27 include an oblong shape. Alternatively, the slots 26, 27 may include any other shape, without any limitations. The slots 26, 27 include an inner portion 28 extending between the top surface 24 and the bottom surface The supporting member 22 disclosed herein includes eight slots 26, 27. However, a number of the slots 26, 27 associated with the supporting member 22 may vary, based on the type of application, without limiting the scope of the present disclosure.

Further, the module mounting system 10 includes a number of mounting assemblies 30, 31, 32, 33. The mounting assemblies 30, 31, 32, 33 couple the supporting member 22 with the structure 14. In the illustrated embodiment, the module mounting system 10 includes four mounting assemblies 30, 31, 32, 33 that are received within the slots 26 of the supporting member 22. However, it should be noted that the remaining slots 27 of the supporting member 22 may also receive one of the mounting assemblies 30, 31, 32. 33, based on system requirements. As shown in FIG. 1, each of the slots 26 receives one of the mounting assembly 30, 31, 32, 33. In another example, each of the slots 26 may receive more than one mounting assembly 30, 31, 32, 33, without any limitations.

For illustrative purposes, the present disclosure will be described with regard to the mounting assembly 30, although it should be understood that the present disclosure is equally applicable to other mounting assemblies 31, 32, 33 of the module mounting system 10. The mounting assembly 30 is movable within the slot 26 along the first axis X-X′ and the second axis Y-Y′, when the supporting member 22 is detached from the structure 14. More specifically, the mounting assembly 30 rotates within the slot 26 about the first axis X-X′ and translates within the slot 26 along the second axis Y-Y′.

Referring to FIG. 2 and FIG. 3, the mounting assembly 30 includes a first mounting member 34 and a second mounting member 36. The first mounting member 34 has a circular shape. The first mounting member 34 includes a first surface 38 and a second surface 40 disposed opposite to the first surface 38. The first surface 38 includes a portion 42 (shown in FIG. 3) abutting with the top surface 24 of the supporting member 22. Specifically, the portion 42 abuts with the top surface 24 of the supporting member 22, thereby restricting movement of the first mounting member 34 in a downward direction along the first axis X-X′. The term “downward direction” referred to herein is defined as a direction towards the bottom surface 25 of the supporting member 22, along the first axis X-X′. The first mounting member 34 also includes a first aperture 46 (shown in FIG. 2) and a second aperture 48 (shown in FIG. 2). The first aperture 46 and the second aperture 48 are embodied as through holes extending between the first surface 38 and the second surface 40. Further, the first and second apertures 46, 48 include internal threads.

Further, the second mounting member 36 includes a first portion 50 and a second portion 52. The first portion 50 extends in an upward direction from the second portion 52, along the first axis X-X′. The term “upward direction” referred to herein is defined as a direction towards the top surface 24 of the supporting member 22. The first portion 50 is received within the slot 26 of the supporting member 22. The first portion 50 includes an outer portion 54 that abuts with the inner portion 28 of the slot 26. Specifically, the outer portion 54 of the first portion 50 forms a clearance fit with the inner portion 28 of the slot 26, which assists in movement of the second mounting member 36 within the slot 26.

The second portion 52 includes an upper surface 56 and a lower surface 58. The upper surface 56 abuts with the bottom surface 25 of the supporting member 22 (shown in FIG. 3). More specifically, the upper surface 56 abuts with the bottom surface 25, thereby restricting movement of the second mounting member 36 in the upward direction along the first axis X-X′.

Also, the second mounting member 36 includes a third aperture 60 (shown in FIG. 2) and a fourth aperture 62 (shown in FIG. 2). The third aperture 60 and the fourth aperture 62 are embodied as a tapped hole and a through hole, respectively. The third aperture 60 and the fourth aperture 62 include internal threads. The fourth aperture 62 extends along the first axis X-X′ through the first portion 50 and the second portion 52.

The mounting assembly 30 includes a first fastening member 64. The first mounting member 34 is coupled with the second mounting member 36 by the first fastening member 64. The first mounting member 34 is aligned with respect to the second mounting member 36 in a manner that the first aperture 46 is aligned with the third aperture 60 for receiving the first fastening member 64 therethrough. The first fastening member 64 has a male threaded portion 66 (shown in FIG. 2) that engages with the internal threads of the first and third aperture 46, 60 to couple the first mounting member 34 with the second mounting member 36. A first washer 68 and a first lock washer 70 are disposed between the second surface 40 of the first mounting member 34 and the first fastening member 64.

Further, the mounting assembly 30 includes a second fastening member 72. The second fastening member 72 couples the first mounting member 34 and the second mounting member 36 with the mounting boss 20 of the structure 14. In order to couple the supporting member 22 with the mounting boss 20, the second aperture 48 is aligned with the fourth aperture 62. Further, the mounting assembly 30 is moved within the slot 26 in a manner that the second aperture 48 and the fourth aperture 62 align with the aperture 21 of the mounting boss 20 in order to receive the second fastening member 72 therethrough.

The second fastening member 72 has a male threaded portion 74 (shown in FIG. 2) that engages with the internal threads of the aperture 21 to couple the supporting member 22 with the mounting boss 20. Further, a second washer 76 and a second lock washer 78 are disposed between the second surface 40 of the first mounting member 34 and the second fastening member 72. In one example, the first fastening member 64 and the second fastening member 72 may include, but are not limited to, an anchor bolt, a rivet, a threaded fastener, a threaded rod, and a screw anchor.

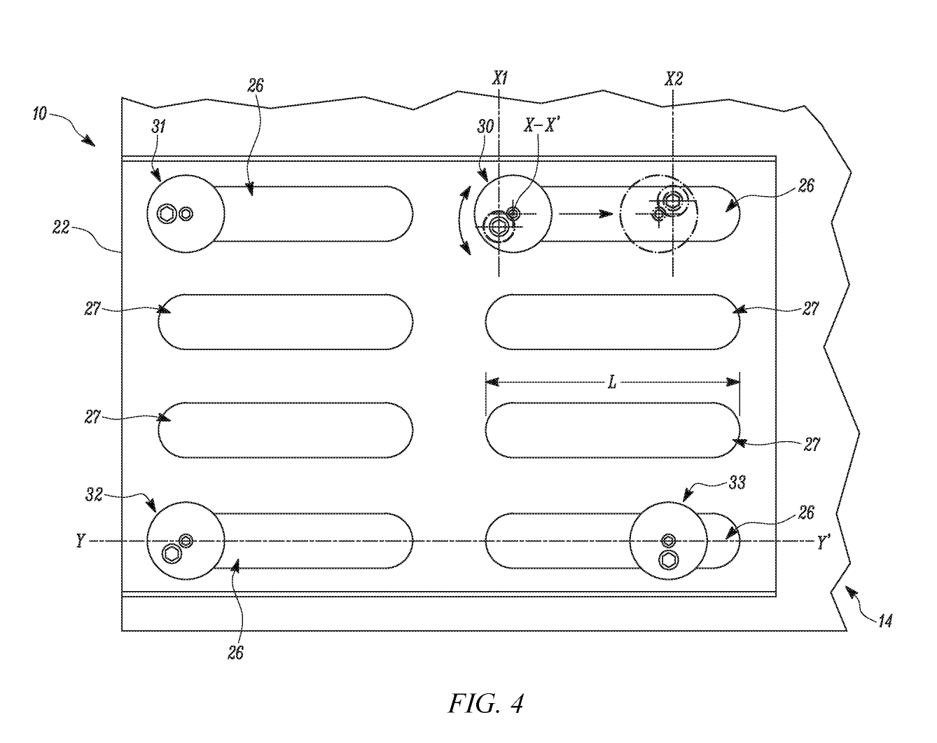

FIG. 4 is a top view of the module mounting system 10 showing the mounting assembly 30 at a first position “X1”. For simplicity purposes, the platform 16 is not shown in the accompanying FIG. 4. It should be noted that the mounting assembly 30 is movable from the first position “X1” to a second position “X2”. More particularly, based on a position of the mounting boss 20 on the structure 14, the mounting assembly 30 may be moved to the second position “X2”, or to any position along the length “L” of the slot 26. In one example, the mounting assembly 30 may be translated along the second axis Y-Y′ to move the mounting assembly 30 from the first position “X1” to the second position “X2”. Further, the mounting assembly 30 may also be rotated about the first axis X-X′ so that the second fastening member 72 of the mounting assembly 30 aligns with the aperture 21 of the mounting boss 20 at the second position “X2”. It should be noted that the mounting assembly 30, 31, 32, 33 can be moved between a number of positions within the slots 26 along the length “L” of the slot 26, based on the position of the mounting bosses 20 on the structure 14, without limiting the scope of the present disclosure.

### INDUSTRIAL APPLICABILITY

The present disclosure relates to the module mounting system 10 for the structure 14. The module mounting system 10 supports the module 12 on the structure 14. The module mounting system 10 allows support and/or mounting of various types of modules thereon. Further, the module mounting system 10 can be coupled to a number of structures of different shapes and sizes.

The module mounting system 10 includes the supporting member 22 having the slots 26 that receive the mounting assemblies 30, 31, 32, 33, The mounting assemblies 30, 31, 32, 33 are adapted to couple with the respective mounting bosses 20 disposed on the structure 14. The mounting assemblies 30, 31, 32, 33 can be rotated and translated within the slots 26, based on the positions of the mounting bosses 20 on the structure 14. This eliminates the requirement of manufacturing specific adapter plates based on the structure 14 and/or the positions of the mounting bosses 20 on the structure 14, thereby reducing overall material cost and overall shipping weight of the packaging unit.

The module mounting system 10 can be used for mounting the modules 12 with different dimensional characteristics, such as a length and a width, on the structure 14. The module mounting system 10 can be associated with a structure of any type of packaging unit or machine used in construction, transportation, power generation, aerospace applications, locomotive applications, marine applications, and other engine power applications.

Further, the module mounting system 10 can be conveniently retrofitted to an existing structure, without modifying or altering design of the module mounting system 10 or the existing structure. The module mounting system 10 does not require hot working, such as welding, cutting, and grinding during design or installation phases. Further, the module mounting system 10 can he reused for different applications, based on requirements. Therefore, the present disclosure offers the module mounting system 10 that is economical, flexible in use, and cost effective.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

What is claimed is:

1. A module mounting system for a structure, the module mounting system comprising:
a supporting member adapted to couple to the structure, the supporting member includes a top surface, a bottom surface disposed opposite to the top surface, and at least one slot extending between the top surface and the bottom surface; and
at least one mounting assembly coupled to the at least one slot, the at least one mounting assembly adapted to couple the supporting member with the structure, wherein the at least one mounting assembly is movable within the at least one slot along a first axis and a second axis, the at least one mounting assembly including:
a first mounting member having a first surface, a first aperture, and a second aperture, wherein a portion of the first surface is adapted to abut with the top surface of the supporting member;
a second mounting member having a first portion, a second portion, a third aperture, and a fourth aperture, the first portion being received within the at least one slot and an upper surface of the second portion being adapted to abut with the bottom surface of the supporting member;
a first fastening member adapted to couple the first mounting member with the second mounting member, wherein the first aperture is aligned with the third aperture to receive the first fastening member therethrough; and
a second fastening member adapted to couple the first mounting member and the second mounting member with the structure, wherein the second aperture, the fourth aperture, and an aperture in the structure are aligned to receive the second fastening member therethrough.
